(19) United States
(12) Patent Application Publication
(10) Pub. No.: US 2003/0231239 A1
(43) Pub. Date: Dec. 18, 2003

(54) Nodal video stream processor and method

(76) Inventor: Brian S. Corzilius, Cloverdale, CA (US)

Correspondence Address: Laura G. Barrow, Esq., P.O. Box 215, Estero, FL, 33928-0215, US

(21) Appl. No.: 10/167,753

(22) Filed: Jun. 12, 2002

(51) Int. Cl. H04N 11/20

(52) U.S. Cl. 348/207.1; 348/453

(57) ABSTRACT

Novel processors and methods of pre-processing video data in-transit from an external video device to an end-user computer are described. The method comprises receiving digital video stream data transmitted on a first video channel from said external video device, transmitting the digital video stream data to a memory for processing by a CPU, processing the digital stream data for transmission via a second video channel, and transmitting the processed video stream data to the end-user computer via the second video channel.

It is emphasized that this abstract is provided to comply with the rules requiring an abstract that will allow a searcher or other reader to ascertain quickly the subject matter of the technical disclosure. It is submitted with the understanding that it will not be used to interpret or limit the scope or meaning of the claims. 37 C.F.R. §1.72(b).

The processing of video data is highly complex and CPU-intensive. Traditionally, custom computer interface cards have been designed to digitize incoming analog video, perform rudimentary processing, and drive the desired display (window). For more complex processing such as target recognition, specialized processor units (independent computers) have been created to post-process video data. With the introduction of true digital video, the process of digitizing the (analog) video has been eliminated but the end-user computer's overhead to prepare the video data for display is still quite high. Typically there will be a camera-to-computer interface card, with the computer's processor acquiring the data from the interface card, transferring it across the internal bus, processing it into displayable data and then driving the display interface. Once again, the CPU overhead is high, and displaying full-motion 30 frame-per-second (fps) video takes an inordinate amount of time, and thus, often times impractical, in desktop computer applications.

The present invention is directed to a device and method for pre-processing video data in-transit from an outside (i.e. external) video source to an end-user computer, thereby reducing or eliminating memory-intensive, time-consuming processing of the data at the end-user computer.

### BRIEF DESCRIPTION OF THE FIGURES

FIG. 1 is a block diagram of the inventive processor showing the components thereof.

FIG. 2A is schematic diagram showing the inventive processor connected to the video device and end-user computer.

FIG. 2B is a general diagram of an IEEE 1394 transmission media cycle of video data, with Video 2 representing packeted video data provided by the inventor processor.

FIG. 3 is a flow chart illustrating the processing of 16-bit YUV 4:2:2 video data into 24-bit RGB data.

### DETAILED DESCRIPTION OF THE EMBODIMENTS OF THE INVENTION

Referring now to the figures, the present invention is directed to a video stream processor 10 comprising a CPU 103, a memory 105, and circuitry 102 operatively connected to an internal bus 106. Network interface ports 101 are provided for connecting the processor 10 to an outside (i.e. external) video device 200 and an end-user computer 300 using conventional transmission media (e.g. IEEE 1394) as discussed in more detail, as shown. As used herein, the term “network” refers to the combination of one or more inventive nodal processors, end-user computer systems, and outside video source(s). Exemplary video devices include, but are not limited to, digital video cameras typically used for surveillance or television viewing wherein the video data transmitted is live or taped video, and cameras transmitting non-moving images (i.e. stills). Exemplary end-user computer systems include, but are not limited to, stand alone or networked desk-top and lap-top (i.e. notebook) computer systems comprising a hard drive, monitor, and user input devices (i.e. keyboards, pointing devices, and the like; PDA's; television systems; security surveillance systems; remotely-controlled or autonomous vehicular control stations; and the like. Preferably, network transmission cables (e.g. IEEE 1394) are employed, although future wireless media transmission embodiments are also within the scope and spirit of the present invention.

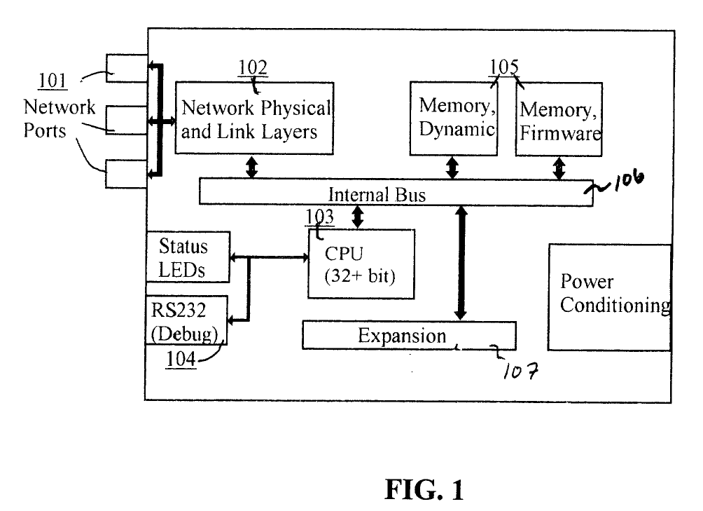

FIG. 1 represents the described invention as based upon the IEEE 1394 transmission medium standard in which several concurrent video devices and/or channels may be connected. The IEEE 1394 standard also provides for asynchronous command and control. It will be appreciated by those of ordinary skill in the art, however, that the inventive processor may employ any network transmission media that supports two or more video channels and some form of command and control. Thus, other exemplary transmission media include, but are not limited to, media described in U.S. Pat. No. 6,084,631 (entitled “High Speed Digital Video Serial Link,” incorporated by reference herein in its entirety), Universal Serial Bus (USB) transmission, parallel video, CameraLink (Pulnix), HotLink (Cypress Semiconductor), and the like. For ease of explanation and illustration, however, the description of the preferred embodiments of the present invention will be referenced to the IEEE 1394 transmission media standard.

Per the IEEE 1394 standard, serial digital video stream data and command directives generated from an outside video source are broadcasted over an assigned isochronous video channel as encapsulated isochronous data. Via the circuitry in block 102, which provides the inventive processor's network interface and address decoding, the inventive processor monitors the specific channel (the assigned channel is specified by a set-up command as sent over the command (asynchronous) transport). Specifically, the processor accesses a copy of the video data being broadcasted on the specific channel. When data packets from the specific channel are seen, the data is routed onto the processor's internal bus 106 by the circuitry in block 102, from which the internal CPU 103 then directs the data into a memory buffer 105. Exemplary CPU's may include any of several kinds currently on the market, including Intel Pentium MMX class devices, provided that the CPU selected be a 32-bit with video/matrix operands as part of the microcode.

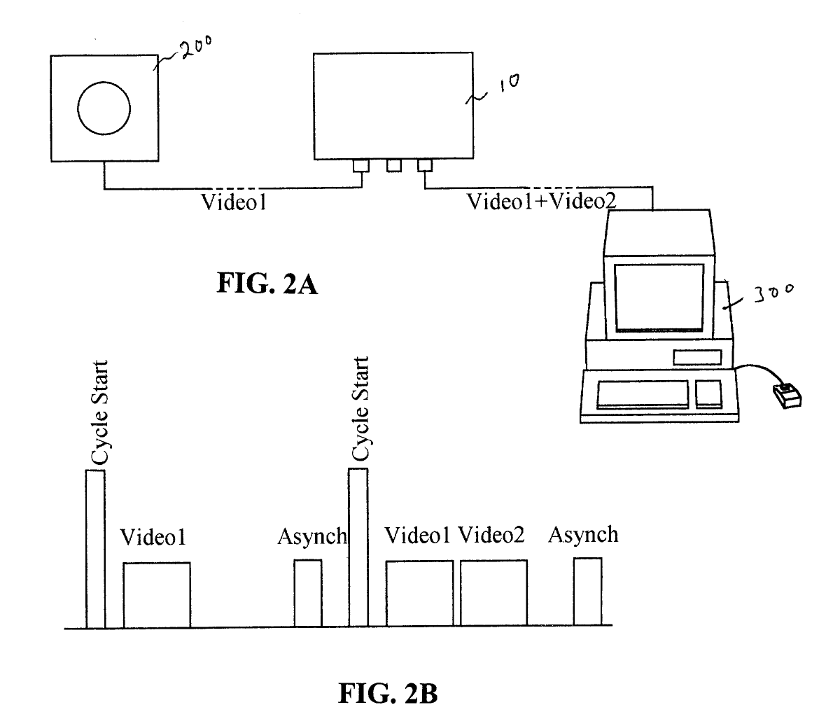

As a full frame of data is received, as indicated by a start-of-frame (e.g., synchronization bit in the packet header), the inventive processor begins processing the data per an algorithm residing in the processor's memory 105. When an entire frame has been processed, the resolved information is then submitted to the network interface within block 102, indicating that the data will be transmitted on a second video channel (or in the case of non-video, sends the results over the asynchronous portion of the transmission media). FIG. 2 presents an overview diagram of the network connections and the generalized packeting of such a functional network.

The inventive processor 10 may also include an RS232 port 104 for algorithm updates and/or development and debugging. LED's may be provided for operational status as well as for use during system debugging. Other embodiments of the inventive may include an expansion port 107 which allows the user to add circuitry to support complex operations, such as target recognition (discuss further below) and others as future needs dictate.

The “processing” of video data monitored and received by the inventive processor 10 on the first video channel and then transmitted, in processed form, onto a second video channel, includes, but is not limited to, (a) conversion of video data from one standard format to another format, (b) auto focus, contrast, and gain controls, (c) feature or target recognition and extraction, and (d) target tracking. At a minimum, the processing of video data by the inventive processor is performed the same as processing of video data performed by CPU's in end-user computers that do not employ the inventive processor. The main difference, however, is that the inventive processor 10 is dedicated to the in-stream processing and transport of video data (at real-time or near real-time speed) enroute to the end-user computer, thus freeing up the end-user computer's CPU to perform other processing functions. It should be further noted, however, that additional nodal processors can be added to the stream, each performing different operations on the same original (i.e. first) video stream. For example, one inventive processor could convert the video format (YUV→RGB), while a second inventive processor could process the video data stream processed by the first video processor to look for specific targets, while a third processor could take that potential target data identified by the second processor and perform tracking algorithms on it.

In addition, the inventive processor 10 may also be programmed to provide secure “blackbox” processing for more complex and protected algorithms. That is, here a new algorithmic code that the author does not want to distribute on disk for security or intellectual property reasons, for example, might instead load the code into the firmware of the inventive processor, distributing the code instead as a new video processing method, thereby reducing the security risk of the algorithmic code being reverse engineered.

Another key feature of the preferred embodiment of the inventive processor is that video data transmitted on the first video channel being monitored (designated as Video 1 in the figures) remains unaltered, while a copy of the video data is taken and processed as described herein, the processed video data being subsequently transmitted on a second video channel (designated as Video 2 in the figures) to the end-user computer. The operator or software of the end-user computer can monitor either channel.

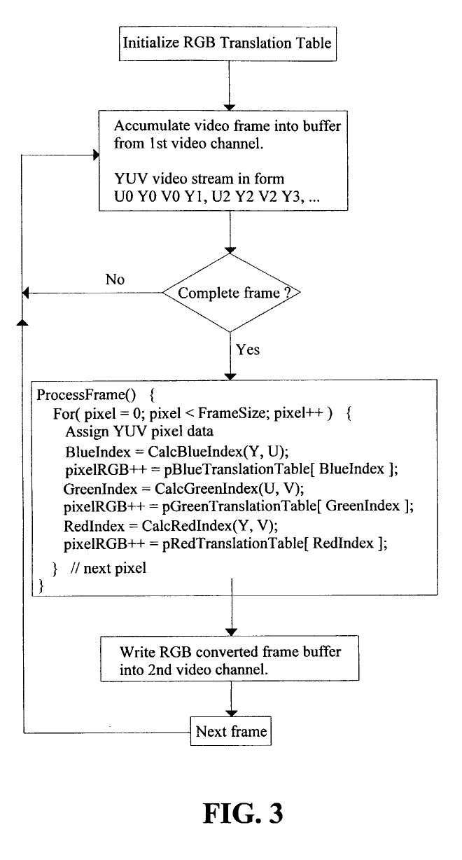

One particular processing application of the inventive processor 10 is the conversion of video luminescence and chroma (YUV) data into conventional red-green-blue (RGB) pixel data that can be directly displayed onto a computer monitor screen of the end-user computer. In a typical scenario, an end-user computer must take the YUV stream from the video source, convert it to RGB, create a bitmap of the RGB data, and then block transfer the data to the screen. Generally, the conversion of the YUV data to RGB requires several calculations and the access of a color lookup table for each resultant pixel on the screen, with the overhead per frame in the tens of milliseconds on a Pentium II processor, for example. The inventive processor, however, can perform the YUV to RGB conversions on the serial digital video stream while in-transit, taking the video data from one video channel and placing the resultant RGB stream on a second video channel, pixel-by-pixel. By performing the YUV to RGB conversion in-stream, the end-user computer overhead required to display the received data is reduced dramatically (to only a few milliseconds on the same Pentium II). FIG. 3 presents C-language code illustrating this particular embodiment. As shown in FIG. 3, at start-up, the CPU's software initializes color translation tables which provide pre-processed color data for faster video conversion. During operation, each frame is received in its own buffer which is then passed to the function Process Frame” (one pass through the Process Frame function processes a single video frame). The ProcessFrame function performs the conversion of the YUV data to the RGB format. The resultant frame (of RGB data) is then directed back onto the network on the appropriate channel by the described invention's processor.

In processing video data comprising feature recognition and extraction, a device comprising feature target recognition software may be connected to an expansion slot 106 provided on the processor 10. Feature recognition and extraction (FRE) processing may be (a) manual, where objects within a frame are determined by potential boundaries (i.e. contrast thresholds, edge detection algorithms, etc.) and the result highlighted or designated for the operator of the end-user computer to move or (b) automatic (e.g. automatic tracking recognition), where potential objects, as determined by methods listed above for manual FRE processing, are checked against a database or learned patterns, as discussed in more detail below. Video data is monitored on the first video channel and moved into the processor's internal memory 105 and stored therein until one or more full frames of video data have been acquired. An art-recognized feature target recognition and extraction algorithm is then applied to this video data stored in the memory to identify one or more pre-programmed feature targets and alert the operator of the end-user computer of such targets. The identification data corresponding to the feature targets is then formatted into one or more asynchronous data messages for concurrent transmission on a second video channel to the end-user computer to alert the operator thereof. Specifically, for example, as potential targets are recognized by the recognition engine, boxes are drawn on the displayed video around the regions of interest (and often with a threat level or recognition code attached) for viewing by the operator of the end-user computer as the operator views the streaming video. The processing algorithm behind such a recognition or threat engine works through a combination of pattern recognition (e.g. from a database or by a previously-taught neural network) and motion recognition (typically motion vectors).

For automatic target recognition applications, one embodiment of the inventive processor would function in a similar manner to that described for video conversion in so far as the inventive processor would monitor the unaltered video on a first video channel, reconstruct the video data in memory, and direct the pattern and motion recognition engine to operate on that image. When a potential ‘target’ is identified, the data corresponding to the frame coordinates and the type of target are formatted into an asynchronous data message. This target-identified data may then be directed to the end-user computer, to the exclusion of full-annotated non-target video data, under limited bandwidth operations. Otherwise, a frame or other designation is drawn over the target image area on the processed video being sent out on the second channel. The end-user computer would then present the target information transmitted asynchronously to the operator (as textual coordinates or other representation) while the operator views the processed video from the second channel. Preferably, this is performed on the live video, but under bandwidth-limited applications (such as remote or unmanned vehicles), the target information and the particular frame (or frames) could then be stored, greatly reducing the storage requirements as is normally seen with recording live video. In both cases, the end-user computer's CPU overhead is nil as all of the CPU-intensive operations have been performed upstream.

Another processing application of the described device is the control of a camera's focus or gain automatically. The invention again would access the serial digital video stream in-transit, examine the pixel-by-pixel relationships performing the well known art of auto-focus or auto-gain control on the data, and then send the resultant video corrections by asynchronous stream back to the video device.

It should further be noted that several algorithms may be stored in the inventive processor's memory to allow for modification of the processing of the video stream via a command submitted by the operator of the end-user computer. By way of the asynchronous (command) channel, the appropriate processing algorithm can be selected into service, thereby allowing processor to perform different functions on said video stream data per said command (e.g. time-based, subject-based, or command-based video processing or analysis). To illustrate in the case of target recognition, for example, once a specific target is recognized, per one algorithm, the operator of the end-user computer may then decide to track the particular target that is recognized via another algorithm. To do this, the operator sends a command to the inventive processor to modify the type of video processing to one that now tracks a target previously recognized. The skilled artisan will appreciate that this function is similar to having two or more inventive processors performing two different functions (i.e. one performing specific target recognition and the other performing target tracking), as described earlier; however, here only one inventive processor is programmed, and thereby has the ability, to perform multiple video processing functions. This particular embodiment of the present invention is thus advantageous when employed with UAV's, for example, where there often exists weight and space constraints.

I claim:

1. A method for distributed pre-processing of video data in-transit from an external video device to an end-user computer, said method comprising:
a. receiving digital video stream data transmitted on a first video channel from said external video device;
b. transmitting said digital video stream data to a memory for processing by a CPU, said memory buffer and CPU operatively connected by an internal bus;
c. processing said digital stream data for transmission via a second video channel; and
d. transmitting said processed video stream data to said end-user computer via said second video channel.

2. The method of claim 1, wherein said processing comprises conversion of said digital video stream data traveling on said first video channel to a different format for subsequent transmission via said second video channel.

3. The method of claim 2, wherein said digital video stream data received on said first channel is YUV luminescence and chroma data, and said processed data stream comprises RGB data converted from said YUV data by said CPU, said RGB data comprising said different format of video stream data.

4. The method of claim 1, wherein said processing comprises applying a feature target recognition and extraction algorithm to said video data stored in said memory to identify one or more pre-programmed feature targets, said processing further comprising formatting identified data corresponding to said feature targets within said processed video stream data transmitted on said second video channel.

5. The method of claim 4, wherein only target identified data is transmitted on said second video channel to the exclusion of full annotated, non-target video data in bandwidth-restricted environments.

6. The method of claim 1, wherein said processing includes providing auto-focus, auto-gain, and contrast corrections to said video stream data.

7. The method of claim 1, wherein said digital stream data remains unaltered during transmission on said first video channel.

8. The method of claim 7, wherein said processing comprises conversion of said digital video stream data traveling on said first video channel to a different format for subsequent transmission via said second video channel.

9. The method of claim 8, wherein said digital video stream data received on said first channel is YUV luminescence and chroma data, and said processed data stream comprises RGB data converted from said YUV data by said CPU, said RGB data comprising said different format of video stream data.

10. The method of claim 7, wherein said processing comprises applying a feature target recognition and extraction algorithm to said video data stored in said memory to identify one or more pre-programmed feature targets, said processing further comprising formatting identified data corresponding to said feature targets within said processed video stream data transmitted on said second video channel.

11. The method of claim 10, wherein only target identified data is transmitted on said second video channel to the exclusion of full annotated, non-target video data in bandwidth-restricted environments.

12. The method of claim 7, wherein said processing includes providing auto-focus, auto-gain, and contrast corrections to said video stream data.

13. A nodal video stream processor for distributive pre-processing video data in-transit from an external video device to an end-user computer, said processor comprising:
a. a CPU, a memory, and circuitry operatively connected by a bus;
b. a network interface operatively connecting said nodal video stream processor to said external video device and said end-user computer, wherein video stream data from said external video device is transmitted to said nodal video stream processor via a first video channel and stored in said memory;
c. said CPU comprising software for processing said video stream data stored in said memory, thereby creating processed video data; and
d. said software further programmed to transmit said processed video data from said memory to said end-user computer via a second video channel.

14. The nodal video stream processor of claim 13, further including an expansion port for connecting modular processing engine devices to said nodal video stream processor.

15. The nodal video stream processor of claim 14, wherein said processing engine device comprises feature target recognition and extraction software, whereby a feature target recognition and extraction algorithm is applied to said video data stored in said memory to identify one or more pre-programmed feature targets, and whereby identification data corresponding to said feature targets are formatted within said processed video stream data transmitted on said second video channel.

16. The nodal video stream processor of claim 13, further including at least one plug-in module connected to said expansion port, wherein one or more of said at least one plug-in module is designed to perform a specific video processing algorithm or analysis.

17. The nodal video stream processor of claim 13, wherein said CPU is programmed to convert said digital video stream data traveling on said first video channel to a different format for subsequent transmission via said second video channel.

18. The nodal video stream processor of claim 17, wherein said digital video stream data received on said first video channel is YUV luminescence and chroma data, and said processed video data comprises RGB data converted from said YUV data by said CPU, said RGB data comprising said different format of video stream data.

19. The nodal video stream processor of claim 13, wherein said CPU is programmed to provide processing selected from auto-focus, auto-gain, and contrast processings.

20. The nodal processor of claim 13, wherein said memory is programmed with two or more different algorithms to allow for modification of said processing of said video stream via a command submitted by an operator of said end-user computer over an asynchronous channel, thereby allowing said processor to perform different functions on said video stream data per said command.

21. A system comprising at least two nodal video stream processors as described in claim 13, and wherein each of said processors operates on said video stream data transmitted on said first video channel and performs different functions on said video stream data.
